(19) United States
(12) Patent Application Publication
(10) Pub. No.: US 2008/0271951 A1
(43) Pub. Date: Nov. 6, 2008

(54) Method for dispensing lubricants, and gas production element for carrying out the method

(75) Inventors: Egon Eisenbacher, Karlstadt (DE); Robert Glier, Rothlein (DE)

Correspondence Address: COLLARD & ROE, P.C., 1077 NORTHERN BOULEVARD, ROSLYN, NY, 11576, US

(73) Assignee: perma-tec GmbH & Co. KG

(21) Appl. No.: 12/070,781

(22) Filed: Feb. 21, 2008

(30) Foreign Application Priority Data
May 5, 2007 (DE) 10 2007 010 518.7

(51) Int. Cl. F16N 11/10; F16N 7/34; F01M 11/10

(52) U.S. Cl. 184/39; 184/55.1; 184/108

(57) ABSTRACT

A method for dispensing lubricants uses a lubricant dispenser that has a lubricant reservoir connected to a housing outlet in a housing, and a gas production region that borders on the lubricant reservoir and accommodates an electrolyte fluid. To start dispensing the lubricant, a galvanic gas production element is introduced into the electrolyte fluid, whereby the lubricant is pressed out of the lubricant reservoir, through the housing outlet, under the pressure of a gas that is produced via electrochemical decomposition of the gas production element. An additional component is introduced into the electrolyte fluid at the same time with the galvanic gas production element, which component is decomposed in the electrolyte fluid during a shorter period of time, with reference to the entire period of operation, with the production of gas, and thereby brings about an increase in the gas production rate, part of the time. A gas production element for carrying out the method is also disclosed.

### CROSS-REFERENCE TO RELATED APPLICATIONS

Applicants claim priority under 35 U.S.C. §119 of German Application No. 10 2007 010 518.7 filed Mar. 5, 2007.

### BACKGROUND OF THE INVENTION

1. Field of the Invention

The present invention relates to a method for dispensing lubricants, using a lubricant dispenser that has a lubricant reservoir connected to a housing outlet in a housing, and a gas production region that borders on the lubricant reservoir and accommodates an electrolyte fluid. To start dispensing the lubricant, a galvanic gas production element is introduced into the electrolyte fluid. A gas is produced via electrochemical decomposition of the gas production element in the electrolyte fluid. The lubricant is pressed out of the lubricant reservoir, through the housing outlet, under the pressure of the gas that is formed by the reaction.

2. The Prior Art

A method having the characteristics described initially is known from DE 42 09 776 C2, whereby the gas production region and the lubricant reservoir are separated by a piston. The housing has a magazine accommodation in the gas production region, which accommodation is closed off via a partition. In order to activate the lubricant dispenser, a magazine having a galvanic gas production element is screwed into the magazine accommodation, whereby the partition is destroyed and the galvanic gas production element is introduced into the electrolyte fluid.

The galvanic gas production element typically is made up of two metals or metal alloys that are connected with one another in electrically conductive manner, whereby the less precious metal acts with the more negative normal potential as an anode, and the more precious metal acts as a cathode. While electrons are given off from the anode to the cathode, and metal ions are given off to the electrolyte fluid, gas is produced via the charge exchange between the electrolyte fluid and the cathode. Immediately after the galvanic gas production element is introduced into the electrolyte fluid, an air volume is present in the gas production region, under atmospheric pressure. This volume must be compressed via the gas to be produced, at least to the pressure that is necessary to overcome the friction on the piston. Until the pressure required to move the piston has been reached, no lubricant is dispensed, so that there is the risk of insufficient lubrication.

Furthermore, it is observed in practice that the viscosity of the lubricant increases with an increasing lubrication period, for example due to partial phase separation in the lubricant. When the lubricant viscosity increases, a higher pressure is required in the gas production region in order to move the piston and to press the lubricant through the housing outlet, thereby causing the lubricant flow to be reduced if the gas production rate remains constant. It must also be taken into consideration, in this connection, that the pressure increase takes place comparatively slowly, because the volume filled with gas increases as emptying of the lubricant reservoir proceeds, and the lubricant dispenser demonstrates an essentially soft behavior with regard to pressure changes.

A lubricant dispenser is known from DE 38 11 469 C2, in which a galvanic gas production element is disposed in a magazine and covered by a foil. During startup of the lubricant dispenser, the foil first has to be destroyed or decomposed. To prevent insufficient lubrication during startup of the lubricant dispenser, the foil is produced from an electrochemically active material, such as aluminum, for example.

This electrochemically active material is destroyed when wetted with the electrolyte fluid to release a gas and thereby bring about a pressure increase in the gas production region only after extensive decomposition of the foil does the electrolyte fluid come into contact with the galvanic gas production element; however, the decomposition and, in particular, the breakup of the foil are not reproducible. Furthermore, the method described requires improvement, because the electrolyte fluid can act only on the side of the foil that faces the gas production region, at first. Also, insufficient lubrication due to an increase in the viscosity of the lubricant, towards the end of the lubrication period, cannot be prevented.

### SUMMARY OF THE INVENTION

With this background, it is an object of the invention to provide a method for dispensing lubricants, using a lubricant dispenser, which method allows more uniform dispensing of lubricant and, in particular, reduces the risk of insufficient lubrication.

These and other objects are achieved, according to the invention, by a method for dispensing lubricant using a lubricant dispenser that has a lubricant reservoir connected to a housing outlet in a housing and a gas production region that borders on the lubricant reservoir and accommodates an electrolyte fluid. To start dispensing the lubricant, a galvanic gas production element is introduced into the electrolyte fluid and the lubricant is pressed out of the lubricant reservoir through the housing outlet under the pressure of a gas that is produced via electrochemical decomposition of the gas production element. An additional component is introduced into the electrolyte fluid at the same time with the galvanic gas production element. This additional component is decomposed in the electrolyte fluid during a shorter period of time, with reference to the entire period of operation, with the production of gas, and thereby brings about an increase in the gas production rate, part of the time. The additional component, just like the gas production element, can be made up of a galvanically active material composition having an increased decomposition rate, or of a substance that reacts violently with the electrolyte fluid. The additional component should be selected as a function of the type of electrolyte fluid. Thus, for example, non-precious metals having a negative normal potential are decomposed in an acid, whereby typically, the reaction speed for different metals increases with an increasingly negative normal potential. With this background, in an acidic solution, magnesium having a normal potential of −2.37 V is particularly suitable as an additional component, for example. In the case of an alkaline electrolyte solution, in contrast, aluminum and silicon, for example, are suitable on the basis of their reaction properties.

In a preferred embodiment, to prevent insufficient lubrication at the beginning of lubricant dispensing, the additional component is directly exposed to the electrolyte fluid when the lubricant dispenser is activated, and is decomposed during the period of a starting phase. It is practical if the amount of the additional component is selected so that the working pressure of the lubricant dispenser is reached during the starting phase, as the result of the decomposition of the additional component.

The additional component can be introduced into the electrolyte fluid at the beginning of lubricant dispensing, together with the galvanic gas production element, as a separate tablet. An embodiment in which the galvanic gas production element and the material of the additional component are connected with one another is particularly preferred.

Alternatively or in addition to the additional component making the working pressure directly available at the beginning of lubricant dispensing, the additional component or a second additional component or both may be encapsulated within the gas production element. In this way, the decomposition of the additional component, the second additional component, or both starts after at least partial consumption of the galvanic gas production element, as emptying of the lubricant reservoir proceeds. For a time period limited with reference to the entire lubrication period, an increase in the gas production rate is thereby brought about towards the end of the lubrication process, so that if an increase in the viscosity of the lubricant occurs, something that is frequently observed in practice, insufficient lubrication can be prevented. The additional component, the second additional component, or both can be enclosed in the galvanic gas production element, so that the electrolyte fluid reaches the additional component and/or second additional component only as decomposition of the gas production element proceeds. Furthermore, separate encapsulation or sheathing, for example on an organic basis, can also be provided, which is slowly decomposed by the electrolyte fluid.

A gas production element for a lubricant dispenser for carrying out the method described is also provided. The gas production element according to the invention has a body containing two base metals. The more precious of the two base metals acts as a cathode in an electrolyte fluid, and the more non-precious base metal acts as an anode, so that an electrochemical gas production reaction proceeds in the electrolyte fluid. In addition, the body has a reactive additional component that is consumed in the electrolyte fluid, producing a gas, over a shorter period of time than the base metals.

In this connection, the invention is based on the idea that the gas production rates can be precisely adapted to the requirements in different phases of the lubrication process. In order to allow quick availability of the working pressure at the beginning of lubricant dispensing when used in a lubricant dispenser, the additional component can be exposed at the surface of the body, which is preferably in tablet form or spherical form, whereby the additional component can be provided, without restriction, merely at a part of the surface, or as an outer layer of the body.

While the slow gas production reaction via electrochemical decomposition of the base metals and the fast gas production reaction via consumption of the additional component start at the same time when the gas production element is immersed into an electrolyte fluid, in the case of only partial coverage of the surface, the slow gas production reaction sets in with a delay if the body is mantled completely. Suitable materials for the additional component are, in particular, magnesium in the case of an acidic electrolyte solution, and aluminum or silicon in the case of an alkaline solution, whereby mixtures or alloys can also be used.

Preferably, zinc and molybdenum or also zinc and copper are used as base metals in an acidic electrolyte fluid. However, the use of metal alloys or of more than two different metals also lies within the scope of the invention. Preferably, the body of the gas production element is pressed from materials present in powder form. A body formed from pressed powder has a large active surface in operation, and can be produced in particularly simple manner, whereby the mixture ratio of the materials in powder form can be varied in particularly simple manner, in order to implement different gas production rates.

In addition or alternatively to the disposition of an additional component on the surface of the body, an additional component can also be provided as the core of the body, which is surrounded by the base metals. The additional component in the core of the body allows a targeted increase in the gas production rate towards the end of the lubrication period. This targeted increase makes it possible to make a sufficient lubricant stream available even if the viscosity of the lubricant increases. In addition to the substances already described, magnesium, aluminum, and silicon, a galvanically active material combination can also be provided as an additional component in the core of the body, which combination is electrochemically decomposed by the electrolyte fluid. Thus, the additional component can be formed, for example, from materials that essentially correspond to the materials of the base metals. The mixture of the materials is more likely to react than the mixture of the base metals, because of a different mixture composition in the additional component, and/or the additional component contains an admixture of a reactive substance such as magnesium, aluminum, or silicon.

The body can be formed in multiple steps, whereby first a core, then the base metals that surround the core, and finally another additional component on the surface of the body are disposed. An additional component may also be provided as a core, formed from a loose, not pressed powder.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 shows the schematic structure of a lubricant dispenser for carrying out the method according to an embodiment of the invention;

FIGS. 2a and 2b are detail views of alternative embodiments of the lubricant dispenser shown in FIG. 1;

FIGS. 3a and 3b show gas production elements for a lubricant dispenser for carrying out the method according to an embodiment of the invention; and

FIG. 4 shows the time progression of the gas production rate and of the pressure in the gas production region of a lubricant dispenser, and of the lubricant flow through the housing outlet.

### DETAILED DESCRIPTION OF PREFERRED EMBODIMENTS

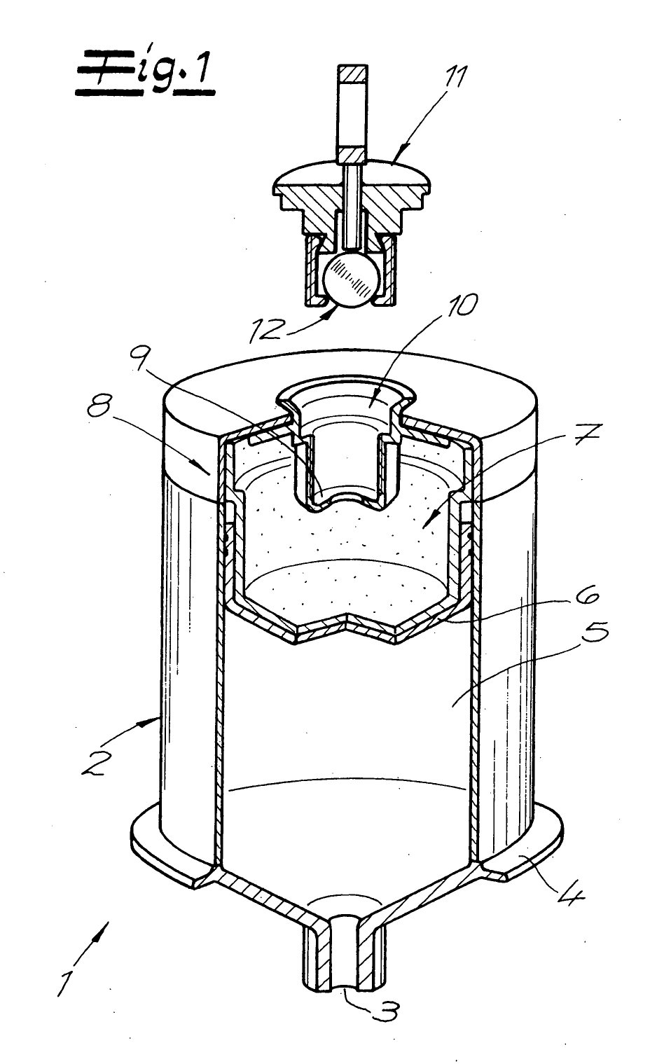

Referring now in detail to the drawings and in particular, FIG. 1 shows the fundamental structure of a lubricant dispenser 1 for carrying out the method according to the invention. Lubricant dispenser 1 has a housing 2 having a housing outlet 3 on a bottom-side lid 4. A lubricant reservoir 5 is connected with housing outlet 3, whereby lubricant reservoir 5 is separated from a gas production region 8 filled with electrolyte fluid 7 via a piston 6. A magazine accommodation 10, closed off by a partition 9, is disposed in gas production region 8.

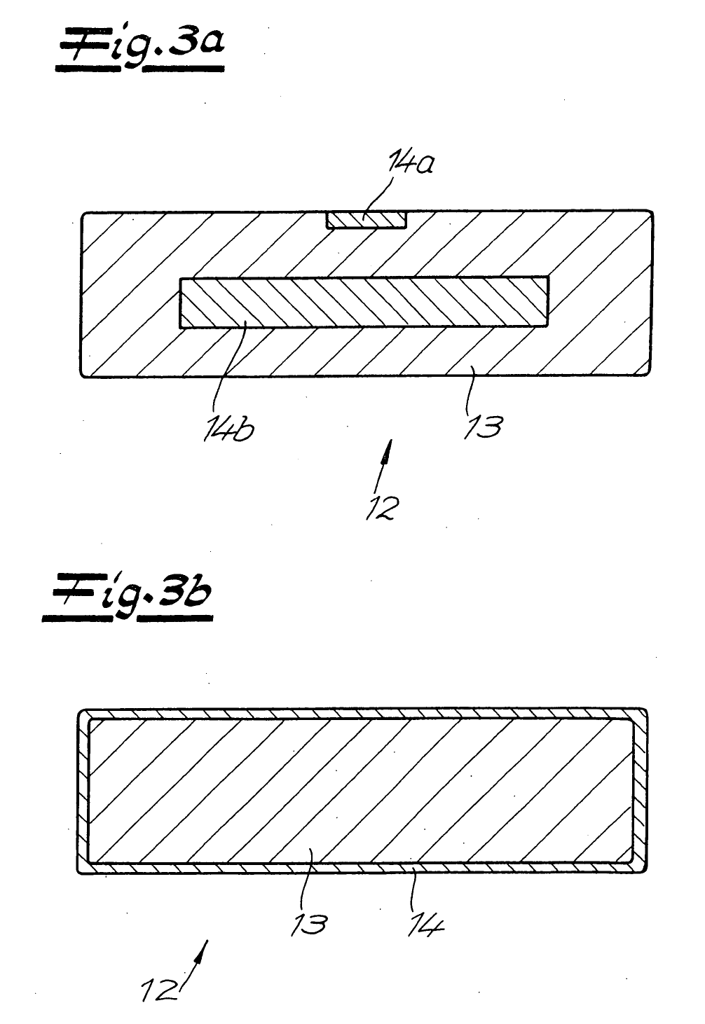

In order to trigger lubricant dispensing, a magazine 11 having a gas production element 12 is screwed into magazine accommodation 10, in gas-tight manner, whereby partition 9 is removed and gas production element 12 falls into electrolyte fluid 7. A gas is formed via the decomposition of gas production element 12 in the electrolyte fluid, which gas brings about an increase in pressure in gas production region 8. The pressure built up in gas production region 8 acts on the lubricant reservoir 5 by way of piston 6, so that lubricant is pressed out through housing outlet 3. Gas production element 12 has a tablet-shaped or spherical body, which is formed from two base metals 13 and at least one reactive additional component 14, 14a, 14b (FIGS. 3a, 3b). An increase in the gas production rate is brought about for a limited period of time, with reference to the entire lubrication period, via the decomposition of the additional component 14, 14a, 14b in electrolyte fluid 7.

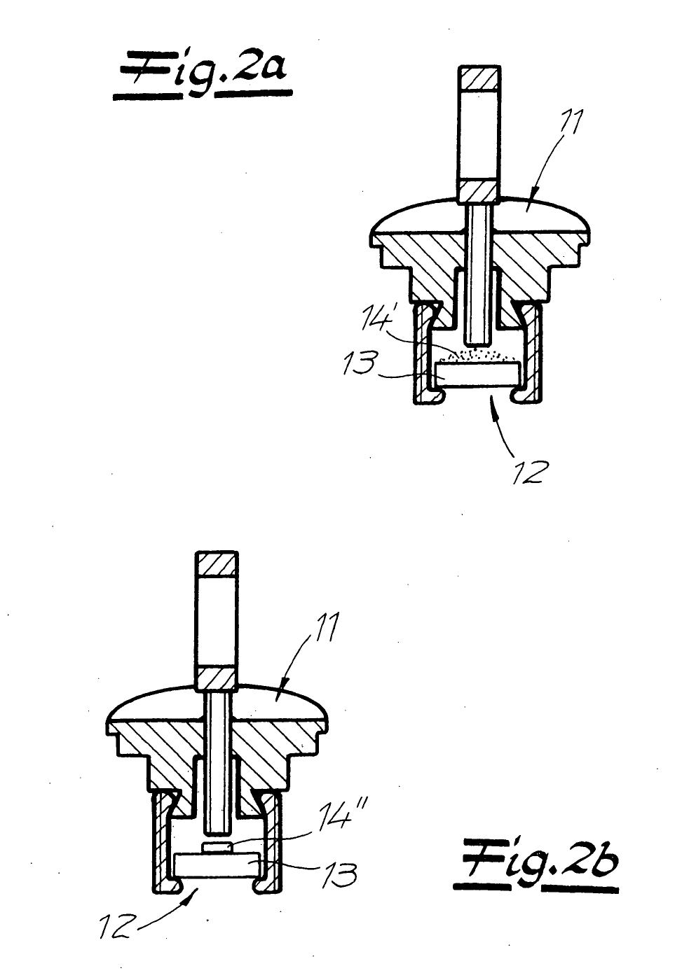

FIGS. 2a and 2b show alternative embodiments, in which galvanic gas production element 12 is formed from base metals 13 and configured as a tablet. The additional component is made available as a grainy material 14′ or a separate tablet 14″. At the beginning of lubricant dispensing, galvanic gas production element 13 and additional component 14′, 14″ are introduced into electrolyte fluid 7 together, so that in the case of the embodiments according to FIGS. 2a and 2b, a slow gas production reaction via electrochemical decomposition of base metals 13 and a fast gas production reaction via the decomposition of additional component 14′ 14″ start at the same time.

FIG. 3a shows a preferred embodiment of gas production element 12 according to FIG. 1. A first additional component 14a is disposed on the surface of the body of gas production element 12, and pressed into the material of base metals 13, which surround a core consisting of a second additional component 14b. FIG. 3b shows an alternative embodiment of gas production element 12, whereby base metals 13 are completely surrounded by first additional component 14, so that the slow gas production reaction via the electrochemical decomposition of base metals 13 starts with a delay, only after at least partial decomposition of first additional component 14.

Base metals 13 can have zinc and molybdenum or copper as galvanically active metals, which are pressed together as a powder. As compared with molybdenum having a normal potential of −0.200 V, zinc, having a normal potential of −0.726 V, is the more non-precious metal and serves as the anode. During electrochemical decomposition, the anode gives off electrons to the cathode, and positively charged metal ions to electrolyte fluid 7, whereby gas is formed via the charge exchange between cathode and electrolyte fluid 7. Because of its reaction properties and its comparatively easy handling, an aqueous solution based on citric acid is particularly suitable as an acidic electrolyte fluid 7. In particular, citric acid is comparatively non-hazardous, as compared with other electrolyte fluids 7, also when filling lubricant dispenser 1 or in the case of a defect of lubricant dispenser 1. When an acidic electrolyte solution is used, in the simplest case, gaseous hydrogen forms as the propellant for lubricant dispenser 1, via the charge exchange at the cathode.

In order to make the required operating pressure available at the beginning of lubricant dispensing, via a fast gas production reaction, magnesium is particularly suitable in an acidic electrolyte fluid 7, and aluminum and silicon are particularly suitable in an alkaline solution.

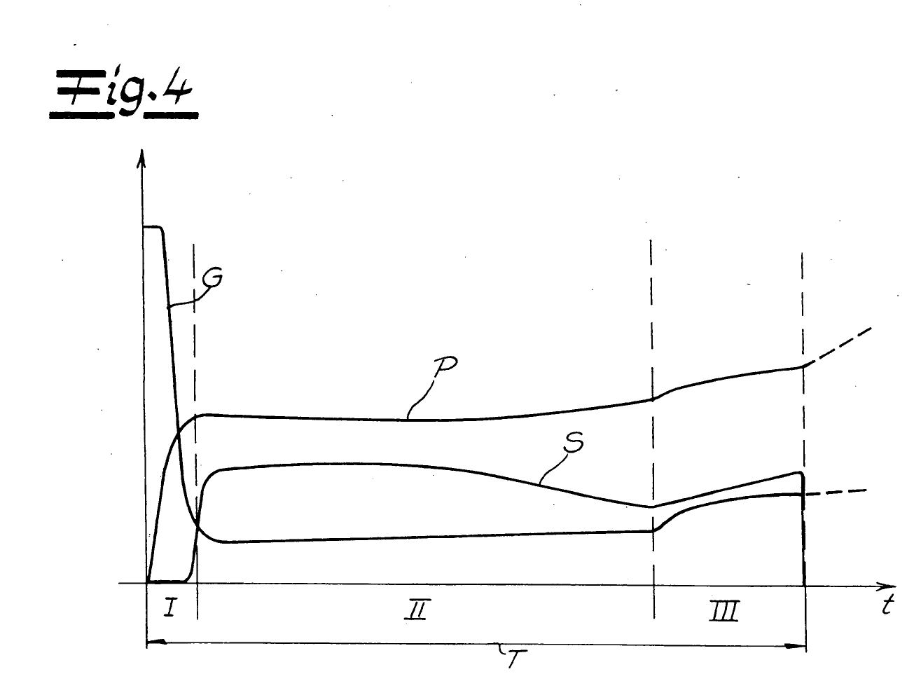

FIG. 4 shows an example of the progression of the gas production rate G and of the pressure P in gas production region 8, and the lubricant flow S through housing outlet 3, over the entire period of operation, whereby an increase in the gas production rate is provided both for the duration of a starting phase I, via first additional component 14a, and, as emptying of lubricant reservoir 5 proceeds, via a second additional component 14b, towards the end of the period of operation T. In a starting phase I stretched in time to make the illustration clear, a fast gas production reaction occurs by means of decomposition of first additional component 14a, so that in a short time, the pressure P required to drive the lubricant out is built up, and lubricant is pressed out through housing outlet 3.

After extensive decomposition of first additional component 14a, a slow gas production reaction takes place in a second phase II, via the electrochemical decomposition of base metals 13, whereby the lubricant flow S through housing outlet 3 is approximately constant at first. As emptying of lubricant reservoir 5 proceeds, an increase in the viscosity of the lubricant is observed, so that on the one hand, the lubricant flow S decreases, and on the other hand, the pressure P in the gas production region 8 is increased.

In order to compensate the decrease in the lubricant flow S, an increase in the gas production rate is provided towards the end of the lubrication period, in a third phase III, via the decomposition of second additional component 14b. Finally, lubrication ends with complete emptying of lubricant reservoir 5.

Accordingly, although only a few embodiments of the present invention have been shown and described, it will become apparent that many changes and modifications may be made thereunto without departing from the spirit and scope of the invention.

What is being claimed is:

1. A method for dispensing lubricants comprising:
(a) providing a lubricant dispenser comprising a housing with a housing outlet, a lubricant reservoir connected to the housing outlet, and a gas production region that borders on the lubricant region and accommodates an electrolyte fluid;
(b) simultaneously introducing a galvanic production element and an additional component into the electrolyte fluid; and
(c) pressing a lubricant out of the lubricant reservoir through the housing outlet under pressure of a gas produced via electrochemical decomposition of the gas production element and the additional component;
wherein the additional component decomposes in the electrolyte fluid during a shorter period of time with reference to an entire period of operation to bring about an increase in the gas production rate during a portion of the operations.

2. The method according to claim 1, wherein the additional component is directly exposed to the electrolyte fluid when lubricant dispensing starts, and is decomposed during a starting phase period.

3. The method according to claim 1, wherein the additional component is encapsulated within the gas production element, wherein the decomposition of the additional component starts after partial consumption of the galvanic gas production element, as emptying of the lubricant reservoir proceeds.

4. Method according to claim 1, wherein a first additional component is directly exposed to the electrolyte fluid when lubricant dispensing starts, and is decomposed during a starting phase period, and wherein a second additional component is encapsulated within the gas production element, wherein the decomposition of the second additional component starts after partial consumption of the galvanic gas production element, as emptying of the lubricant reservoir proceeds.

5. A gas production element for carrying out a method for dispensing lubricants comprising:
(a) an electrolyte fluid; and
(b) a body containing first and second base metals and a reactive additional component;
wherein the first base metal is more precious than the second base metal;
wherein the first base metal acts as a cathode and the second base metal acts as an anode in the electrolyte fluid so that an electrochemical gas production reaction takes place in the electrolytic fluid; and
wherein the reactive additional component is consumed in the electrolyte fluid to produce a gas during a shorter period of time than the time gas is produced by electrochemical decomposition of the first and second base metals.

6. The gas production element according to claim 5, wherein the body is pressed from metals present in powder form.

7. The gas production element according to claim 5, wherein the body comprises a tablet or a sphere.

8. The gas production element according to claim 5, wherein the reactive additional component is exposed on a surface of the body.

9. The gas production element according to claim 8, wherein the additional component forms an outer layer of the body.

10. The gas production element according to claim 5, wherein at least a part of the additional component forms a core of the body surrounded by the first and second base metals.

11. The gas production element according to claim 10, wherein the additional component comprises a grainy material.

12. The gas production element according to claim 5, wherein the reactive additional component comprises magnesium, aluminum, silicon, or a mixture or alloy using at least one of magnesium, aluminum, and silicon.

13. The gas production element according to claim 5, wherein the additional component comprises a mixture of two metals that form an anode and a cathode in the electrolyte fluid, and wherein said mixture is more reactive in the electrolyte fluid than the first and second base metals.

14. The gas production element according to claim 13, wherein the two metals of the additional component are identical to the first and second base metals, the two metals of the additional component being present in a more reactive mixture ratio than the first and second base metals.
